(19) United States
(12) Patent Application Publication
(10) Pub. No.: US 2011/0133430 A1
(43) Pub. Date: Jun. 9, 2011

(54) AIR BRAKE CONNECTION SYSTEM

(76) Inventor: Colin Anthony Morris, Worcestershire (GB)

(21) Appl. No.: 12/997,103

(22) PCT Filed: Jun. 12, 2009
(86) PCT No.: PCT/GB2009/050667

§ 371 Date: Feb. 11, 2011

(30) Foreign Application Priority Data
Jun. 12, 2008 (GB) 08 10783.1
Dec. 12, 2008 (GB) 08 22673.0

(51) Int. Cl. B60D 1/62; B60D 1/64; F16L 11/00

(52) U.S. Cl. 280/421; 138/118

(57) ABSTRACT

An air brake connection system includes a tractor fitting (18) and a trailer fitting (5). A hose (8) has fittings (21, 11) at its opposite ends that are uncouplably connectable to the tractor fitting (18) and to the trailer fitting (5). Each tractor fitting (18, 19) may incorporate a self-sealing valve. In use, if an air hose fails, it can be simply uncoupled from both tractor and trailer and replaced with a spare hose.

The present invention relates to an air brake hose system, and to a system for connecting air brake hoses.

An articulated lorry, comprising a tractor and trailer, has flexible air brake lines or hoses extending between tractor and trailer. These are coils of nylon tubing, known as Susie coils. For uncoupling of the trailer, the hoses are disconnectable from the trailer. In use, the tractor maintains an elevated air pressure in those airlines that communicate with the trailer, and as long as the pressure is maintained above a threshold value the brakes are not applied, while if the pressure drops below the threshold value the brakes are applied. For example the threshold value may be 65 psi (4.3 bar).

The hoses are subject to considerable wear and tear. They are liable to fail. Failure of the primary air hose causes the brakes of both the tractor and trailer to be applied. The vehicle cannot be moved until the hose has been repaired.

Generally repair must be carried out by a qualified fitter. The driver of the vehicle is not permitted under safety regulations to make repairs to the hoses.

Conventionally, air brake hoses are permanently connected to the tractor and uncouplably connected to the trailer.

It is known in a different automotive application to provide air line extensions for inflating tyres and the like with male and female quick release couplings at opposite ends.

The object of the present invention is to provide an improved air brake hose system.

According to the invention there is provided an air brake connection system comprising a tractor fitting, a trailer fitting, and a hose having fittings at its ends that are uncouplably connectable to the tractor fitting and to the trailer fitting.

In use, should the hose fail, it is uncoupled from both tractor and trailer and replaced with a spare hose. This is a few minutes job, involving no skill on behalf of the driver beyond that with which he is used in coupling his tractor to a trailer, when he has to couple the air hoses.

Preferably the system will include uncouplably connectable hoses of each type, that is to say the primary or supply line and the secondary line where provided. The uncouplable connections may be connections of the male/female type, or connections of the glad hand type; on any one hose the connections at the two ends may be of the same type, or alternatively the connection at one end of the hose may be of the male/female type while the connection at the other end of the hose may be of the glad hand type.

Preferably the or each hose includes a self-sealing valve at the end connectable to the trailer fitting, that is to say a valve that seals as the hose is disconnected and opens as the hose is connected. Preferably the or each tractor fitting includes means to close off the air supply, preferably a self-sealing valve.

Where there are two such hoses, preferably the corresponding trailer fittings are different, to avoid connecting the hose to the wrong trailer fitting.

Preferably the uncouplably connectable hoses will have couplings at their tractor end which are different from those at their trailer end, for example being complementary to those at their trailer end. This ensures that a hose cannot be connected the wrong way round. Thus a hose, intended to be connected to a valveless male coupling on the trailer and so with a self-sealing female coupling on the trailer end of the hose to retain pressure in the tractor when the hose is disconnected, will have a valveless male coupling at the tractor end of the hose; and there would be a self-sealing female coupling on the tractor. Where there are two such hoses, the fittings at the tractor end may differ from those at the trailer end, for example having a different diameter; this would ensure that a hose cannot be connected the wrong way round in place of the other type of hose.

In the preferred embodiment, the tractor ends of the hoses are locked to the tractor, to avoid their unauthorised removal. For example they may be enclosed within a lockable box.

The present invention also provides a hose suitable for use in the connection system of the invention. The invention also provides a tractor unit incorporating at least one tractor fitting to which such a hose can be uncouplably connected.

To help understanding of the invention, specific embodiments thereof will now be described, by way of example only, and with reference to the accompanying drawings, in which:

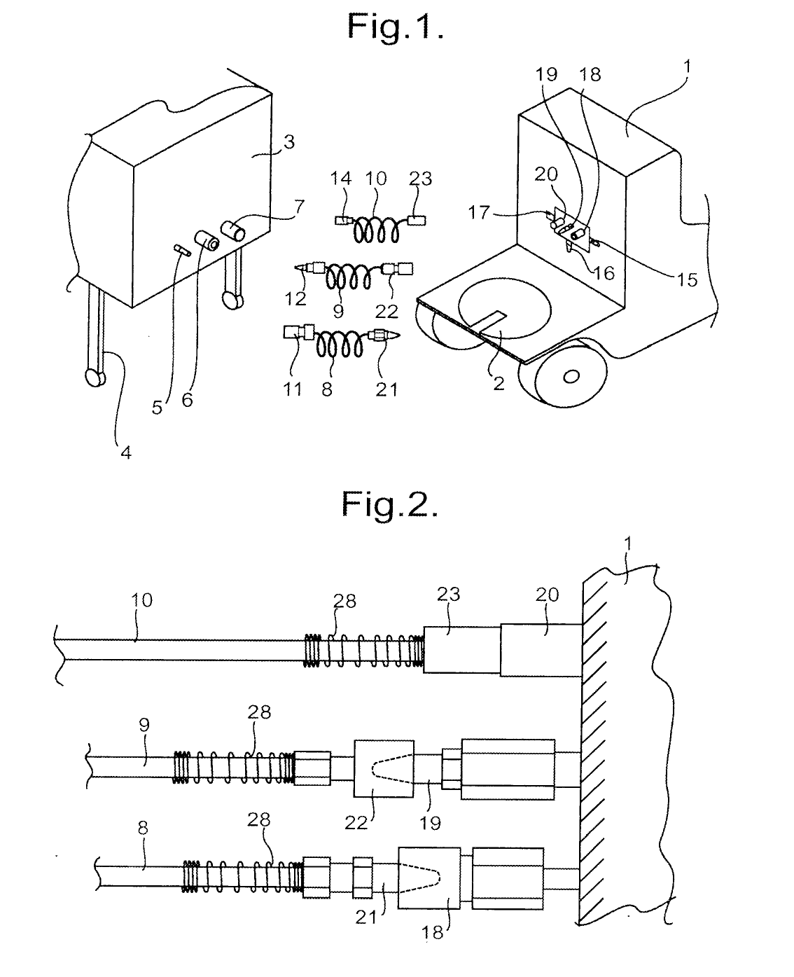

FIG. 1 is a scrap diagrammatic view of a tractor and trailer and their brake hoses;

FIG. 2 is a more detailed plan view of the tractor end of the hoses connected to the tractor;

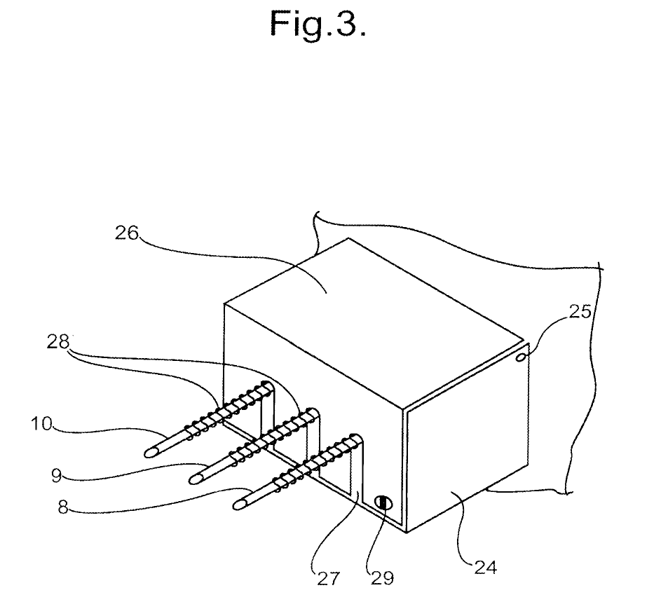

FIG. 3 is a perspective view of a locking box for the tractor end of the hoses; and

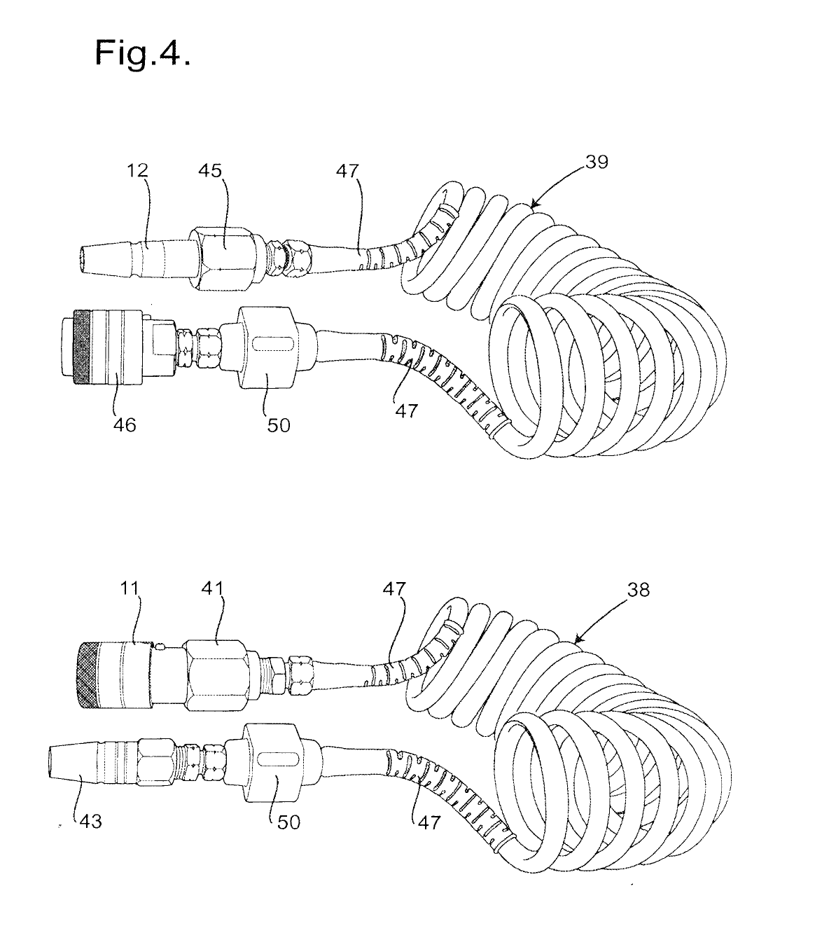

FIG. 4 shows a perspective view of alternative brake hoses for use with a tractor and trailer as in FIG. 1.

Referring to the drawings, FIG. 1 shows in scrap view the rear of a tractor 1 including its towing turntable 2, and a scrap view of a semi-trailer 3 with its parking legs 4. In the typical arrangement the tractor 1 and trailer 3 must be linked by a primary or emergency air line (typically a red hose), and by a secondary or regular air line (typically a yellow hose), and by an electrical cable. The trailer 3 in this example has conventional air line couplings, namely a male, primary or supply line coupling 5, and a female secondary line coupling 6; there is also a coupling 7 for an electrical control cable. Between the tractor and trailer are diagrammatically shown coiled primary and secondary air line hoses 8 and 9, and an electrical control cable 10. These have female primary and male secondary couplings 11 and 12, and a conventional electrical connector 14, at the ends connectable to the trailer 3. The couplings 11 and 12 both include self sealing valves (not visible) to provide that the lines are sealed when the hoses 8 and 9 are disconnected.

The tractor 1 has conventional dummy couplings 15, 16, 17 for receiving the ends of the hose end couplings 11, 12 and the connector 14 when not in use.

In accordance with the invention, and referring also to FIG. 2, the tractor 1 also has self-sealing couplings 18 and 19 which are equivalent to the self-sealing couplings 11 and 12, although fixedly connected as opposed to being connected to the hoses 8 and 9. There is also an electrical connector 20. The tractor ends of the hoses 8 and 9 have couplings 21 and 22 which are equivalent to the trailer fixed couplings 5 and 6.

The tractor end of the control cable 10 includes a conventional electrical connector 23 connectable to the connector 20. In FIG. 2 the hoses 8 and 9 are shown connected to the self-sealing couplings 18 and 19 on the tractor 1, the male elements being shown in broken lines. Thus each hose 8 and 9 (and indeed also the electrical cable 10) can be disconnected from the trailer 3 routinely, and can whenever necessary be disconnected from the tractor 1 for replacement. The hoses are not inter-changeable, because the respective couplings are provided in complementary pairs which do not inter-connect—in accordance with British Standard BS AU 138b: 2000.

For simplicity in construction, the self-sealing couplings 18 and 19 fixed to the tractor 1 may be substantially identical to the self-sealing couplings 11 and 12 on the trailer end of the hoses 8 and 9.

As shown in FIG. 3 (but not in FIGS. 1 & 2), the tractor couplings are provided with a locking box 24 with a hinge 25 for a closure 26. This has slots 27 through which the hoses protrude in use at their spiral wire protectors 28. When a lock 29 is engaged, the hoses cannot be removed from the tractor 1.

Preferably the air hoses 8 and 9 are colour-coded in the conventional way. Hence the set of air hoses 8 and 9 that are in use would consist of a red hose 8 and a yellow hose 9. The red hose 8 would have a female coupling 11 that incorporates a self-sealing valve at one end, and a male coupling 21 at the opposite end. Similarly the yellow hose 9 would have a male coupling 12 that incorporates a self-sealing valve at one end, and a female coupling 22 at the opposite end. The driver would carry an identical pair of such red and yellow hoses 8 and 9 for use in the case of failure in one of the air hoses.

Referring now to FIG. 4 there are shown a replacement red hose 38 and a replacement yellow hose 39 for use a braking system as described above. Such a pair of replacement hoses 38 and 39 might constitute a repair kit to be carried in the cab of the tractor 1. In a similar way to that described above, the red hose 38 is provided with a female coupling 11 that incorporates a self-sealing valve 41 at the end for connection to the trailer 3, and a male coupling 43 at the end for connection to the tractor 1. The yellow hose 39 is provided with a male coupling 12 incorporating a self-sealing valve 45 at the end for connection to the trailer 3, and a female coupling 46 at the end for connection to the tractor 1. The ends for connection to the tractor 1 are further distinguished by an oval plastic moulding 50. In this example the end portions of the hoses 38 and 39 are provided with plastic reinforcement covers 47 in place of the spiral wire protectors 28 shown in FIGS. 2 and 3.

At the end for connection to the trailer 3, the couplings 11 and 12 of the hoses 38 and 39 are identical to those described earlier, and are therefore compatible with standard couplings 6 and 7 on the trailer 3. In this case, however, the couplings 43 and 46 for connection to the tractor 1 are of a different diameter to the couplings 11 and 12 for connection to the trailer 3. Consequently the couplings 18 and 19 fixed to the back of the tractor 1 will have to be of this different diameter too.

Hence, although each hose 38 and 39 has a male coupling at one end and a female coupling at the other end, these are of different diameters and are therefore not compatible with each other. Not only are the ends for connection to the tractor 1 readily distinguished by the provision of the moulding 50, the couplings 11 and 12 intended for connection to the trailer 3 cannot be accidentally connected to the couplings 18 and 19 fixed to the tractor 1 because those couplings would in this case be of a different diameter, and so would not be compatible. This ensures that the hoses 38 and 39 cannot be incorrectly connected.

1: An air brake connection system comprising a tractor fitting, a trailer fitting, and a hose having fittings at its opposite ends that are uncouplably connectable to the tractor fitting and to the trailer fitting, the hose including a self-sealing valve at the end connectable to the trailer fitting.

2: An air brake connection system comprising two air brake connection systems as claimed in claim 1, for two different air supplies.

3. (canceled)

4: An air brake connection system as claimed in claim 1 wherein the tractor fitting includes a self-sealing valve.

5: An air brake connection system as claimed in claim 2 wherein the uncouplable hoses have couplings at their tractor end which are complementary to those at their trailer end

6: An air brake connection system as claimed in claim 2 wherein the uncouplable hoses have couplings at their tractor end which are of a different type to the couplings at their trailer end.

7: An air brake connection system as claimed in claim 2 wherein the couplings at the tractor end are of a complementary shape to those at the trailer end but are of a different diameter.

8: An air brake connection system as claimed in claim 2 wherein the tractor ends of the hoses are locked to the tractor, to avoid their unauthorised removal.

9. An air brake connection system as claimed in claim 8 wherein the tractor ends of the hoses are enclosed within a lockable box.

10: An air brake hose for use in an air brake connection system as claimed in claim 1, the hose having fittings at its opposite ends that are uncouplably connectable to the tractor fitting and to the trailer fitting, the fitting that is uncouplably connectable to the trailer fitting incorporating a self-sealing valve.

11. (canceled)

12: A repair kit for an air brake connection system as claimed in claim 2, the repair kit comprising two hoses with fittings that would be uncouplably connectable to the tractor fitting and to the trailer fitting, each hose including a self-sealing valve at the end connectable to the trailer fitting.

13: A tractor unit incorporating at least one tractor fitting to which a hose as claimed in claim 10 can be uncouplably connected.

14. A tractor unit as claimed in claim 13 wherein the tractor fitting incorporates a self-sealing valve.
